(19) United States
(12) Patent Application Publication
(10) Pub. No.: US 2026/0035495 A1
(43) Pub. Date: Feb. 5, 2026

(54) FUNCTIONAL COPOLYMERS AND METHODS OF PREPARATION THEREOF

(71) Applicant: Kraton Corporation, The Woodlands, TX (US)

(72) Inventors: Marianne Stol, Amsterdam (NL); Evan Haidasz, Hoboken, NJ (US)

(73) Assignee: Kraton Corporation, The Woodlands, TX (US)

(21) Appl. No.: 19/285,089

(22) Filed: Jul. 30, 2025

Related U.S. Application Data
(60) Provisional application No. 63/678,099, filed on Aug. 1, 2024.

(51) Int. Cl. C08F 36/08; C08F 36/06

(52) U.S. Cl. CPC C08F 36/08; C08F 36/06

(57) ABSTRACT

This disclosure relates to a process for preparing a copolymer via anionic polymerization of at least one conjugated diolefin monomer and a functional comonomer containing nitrogen-based or heteroatom-substituted groups. The functional comonomer is incorporated in an amount of 0.1 to 20 mol %. and may undergo 1-10 addition, 1-5 addition, or 1-2 addition during polymerization. The process occurs in an organic solvent using an anionic initiator and optionally includes divinylbenzene (DVB) to produce a coupled copolymer with improved properties. The functional comonomer may be selected to either increase the vinyl content of the diene repeat units or maintain low vinyl microstructure, depending on application requirements. Termination is achieved with a proton donor, and the copolymer may optionally be hydrogenated using a transition metal catalyst. The resulting copolymer contains pendant functional groups that improve compatibility or reactivity in end-use applications such as elastomers, adhesives, or engineered thermoplastic blends.

### RELATED APPLICATIONS

This application claims priority from U.S. Provisional Application No. 63/678,099 with a filing date of Aug. 1, 2024, the disclosure of which is incorporated herein by reference.

### FIELD

The disclosure relates to a process of preparing a copolymer comprising at least one diolefin monomer and a novel functional comonomer containing at least one aminic nitrogen, and applications thereof.

### BACKGROUND

Interest in the field of functionalized polymeric materials stems from the desire to combine the unique properties of a functional group with those of a high molecular weight polymer.

Polymers derived from diene monomers such as polydienes are apolar materials. Introducing functionality or polarity into these polymers can significantly enhance their properties, making them particularly suitable in polymer blends. A versatile method to achieve this is through the introduction of specifically interacting groups, which improves miscibility. These functionalized polymers find many uses, e.g., membranes, packaging, dispersants, adhesives, coatings, anti-wear applications, etc. In addition, functionalized polymers may be used to modify existing materials to alter their adhesion, processability, solubility, dyeability, thermal, mechanical, and other properties.

There is still a need for an improved process which leads to highly efficient incorporation of the functionality into the polymer structure by making use of the comonomer's reactivity in the process.

### SUMMARY

In one aspect, a process for preparing a copolymer comprising the steps of (a) copolymerizing: (i) at least one diolefin monomer selected from the group consisting of: 1,3-butadiene, isoprene, and mixtures thereof and (ii) a functional comonomer having a structure of formula (I),

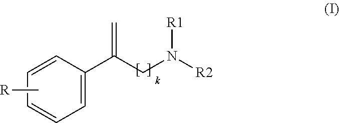

where k is an integer from 1 to 3, R is any of hydrogen or a phenyl ring, R1 and R2 are each independently a hydrocarbyl group or a hydrocarbonaceous group having 1 to 4, additional heteroatoms selected from the group consisting of O, N, S, P, Se, and combinations thereof, R1 and R2 are connected to form a moiety containing at least one 5- to 12-membered ring and 3 to 28 carbons. The mole ratio of (i) to (ii) in a range of 0.001 to 0.2, forming the copolymer with a reactive chain end comprising diene repeat units derived from the diolefin monomer and repeat units derived from the functional comonomer, wherein the copolymer has a vinyl moiety in the diene repeat units. It further comprising steps (b) optionally adding divinylbenzene (DVB) to the reaction mixture containing the copolymer with a reactive chain end, (c) terminating the copolymerization by adding a proton donor selected from the group consisting of alcohol, hydrogen, water, and mixtures thereof, and (d) optionally hydrogenating the copolymer via a hydrogenation catalyst

In a second aspect, the moiety formed by connecting R1 and R2 further comprises 1 to 6 additional heteroatoms selected from the group consisting of O, N, S, P, Se, and combinations thereof.

In a third aspect, the functional comonomer is incorporated into the copolymerization by any of: 1-10 addition, 1-5 addition, or 1-2 addition.

In a fourth aspect, the functional comonomer when used in an organic solvent,

increases the vinyl moiety of the diene repeat units by at least 20% in the absence of a vinyl modifier, wherein the organic solvent is an apolar solvent.

In a fifth aspect the functional comonomer, when used in an organic solvent, maintains the vinyl moiety in the diene repeat units at less than 15% in the absence of an additional vinyl modifier.

### DESCRIPTION

The following terms will be used throughout the specification:

“Consisting essentially of” means that the composition primarily includes the recited components and may additionally contain one or more components that do not materially affect the novel characteristics or intended function of the invention. In embodiments, such additional components are present in amounts of <30 wt. %, <20 wt. %, or <10 wt. %, based on total weight of the composition.

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other combinations of A, B, and C. In another example, at least one of A and B means A only, B only, as well as A and B.

A list of embodiments presented as “A, B, or C” is to be interpreted as including the embodiments, A only, B only, C only, “A or B,” “A or C,” “B or C,” or “A, B, or C.”

“Any of A, B, or C” refers to one option from A, B, or C.

“Any of A, B, and C” refers to one or more options from A, B, and C.

“Molecular weight” or M_{w} refers to the polystyrene equivalent molecular weight in g/mol of a polymer block or a block copolymer. M_{w} can be measured with gel permeation chromatography (GPC) using polystyrene calibration standards, such as is done according to ASTM 5296. The GPC detector can be an ultraviolet or refractive index detector or a combination thereof. The chromatograph is calibrated using commercially available polystyrene molecular weight standards. M_{w} of polymers measured using GPC so calibrated are polystyrene equivalent molecular weights or apparent molecular weights. M_{w} expressed herein is measured at the peak of the GPC trace and is commonly referred to as polystyrene equivalent “peak molecular weight,” designated as Mₚ.

“Polymer unit” as used herein refers to the unit of a polymer chain which is formed by, and corresponds to, one monomer.

“Monovinyl arene,” or “monoalkenyl arene,” or “vinyl aromatic” refers to an organic compound containing a single carbon-carbon double bond, at least one aromatic moiety, and a total of 8 to 18 carbon atoms, such as 8 to 12 carbon atoms. The “% wt.” as used herein refers to the number of parts by weight of

monomer per 100 parts by weight of polymer on a dry weight basis, or the number of parts by weight of ingredient per 100 parts by weight of specified composition.

“Microstructure” refers to the mode of addition of a conjugated diene monomer unit to the growing polymer chain. Either 1,2-addition, 1,4-addition, or 3,4-addition can occur.

“Coupling efficiency” refers to the weight of molecules of coupled polymer divided by the weight of molecules of coupled polymer plus the weight of molecules of uncoupled polymer. For example, if a coupling efficiency is 80%, then the polymer will contain 20 wt. % of diblock and 80 wt. % of triblock and multi-arm blocks.

“Divinylbenzene nucleus” refers to a divinylbenzene moiety incorporated into the polymer backbone through reaction at one or both vinyl groups, optionally linking two polymer chains.

“Nucleus” refers to the core or central part of the polymer from which multiple polymer chains (arms) emanate.

This disclosure relates to a process for preparing a copolymer via anionic polymerization of at least one diolefin monomer and a functional comonomer comprising at least one aminic nitrogen. The functional comonomer is used in an amount of 0.1 to 20 mol %. Incorporation of the functional comonomer during polymerization step is controlled by regioselective addition, selected from any of 1-10 addition, 1-5 addition, or 1-2 addition. The functional comonomer exhibits a unique reactivity ratio in a copolymerization with diolefin monomers compared to other styrenic monomers. The use of such a selective comonomer enables the formation of vinyl moieties in a manner comparable to or improved over non-functionalized processes, while concurrently introducing functional groups into the copolymer backbone.

(Diolefin Monomer): The diolefin monomer contains conjugated carbon-carbon double bonds having a total of 4 to 12 carbon atoms. In embodiments, the diolefin monomer is selected from group consisting of 1,3-butadiene, substituted butadiene including but not limited to 1,3-cyclohexadiene, isoprene, 2,3-dimethyl-1,3-butadiene, 1-phenyl-1,3-butadiene, 1,3-pentadiene, 3-butyl-1,3-octadiene, farnesene, myrcene, piperylene, and combination thereof. In embodiments, the conjugated diene block comprises a mixture of butadiene and isoprene monomers. In embodiments, isoprene alone is used.

As used herein, the term “diolefin monomer” is used interchangeably with “diene monomer” and “conjugated diene monomer.”

In embodiments, the conjugated diene portion of the diolefin monomers is represented by [C^{1═}C²═C^{3═}C^{4]} formula. Anionic polymerization of a conjugated diene results in a polymer with all four of these carbon atoms incorporated into the polymer backbone or, alternately, only two of these carbons (C¹—C² or C³—C⁴) incorporated into the polymer backbone. In embodiments, the incorporation of all four carbons in the polymer backbone occurs by way of a 1,4-addition in the case of butadiene. Alternately, the incorporation of only two carbons in the polymer backbone proceeds by 1,2-addition for butadiene. In the case of isoprene, incorporation of only two carbons in the polymer backbone proceeds by 3,4-addition. 1,2-or 3,4-addition of butadiene and isoprene, respectively, yields a group pendant to the polymer backbone. These groups are referred to as a vinyl group. The amount of vinyl group present in the conjugated diene block is referred to as vinyl content.

As used herein, the term “vinyl content of the diene repeat units” refers to the proportion of diene-derived repeat units (such as those derived from 1,3-butadiene or isoprene) that contain vinyl microstructure resulting from 1,2-addition (in butadiene) or 3,4-addition (in isoprene) during polymerization. The vinyl content is typically expressed as a mole percent of the total diene repeat units and can be determined using techniques such as ¹H-NMR spectroscopy, which distinguishes between vinyl and 1,4-incorporated structures. The vinyl content may vary depending on the solvent polarity, functional comonomer identity, or the presence or absence of a vinyl modifier. This parameter is an important characteristic of the polymer microstructure and is used herein to describe and differentiate copolymers formed under different process conditions.

In embodiments, the polymers derived from diene comonomers, such as polydienes, are apolar material. The microstructure of a polydiene homopolymer is formed during the polymerization process. In embodiments, the microstructure of the polydiene is modified to an extent that it results in increased pendant vinyl moieties (detectable by ¹H NMR), meaning the presence of vinyl microstructure is increased with an increase of pendant vinyl moieties.

In embodiments, the formation vinyl microstructure is controlled with any of: selection of functional comonomer, solvent, or addition of modifiers. In embodiments, the formation of vinyl microstructure is controlled for an increase (vinyl moiety) of at least 20 mol %, or at least 30 mol %, or at least 40 mol %, or 20-80 mol %, or <80 mol %. In embodiments, the polydiene has a vinyl content of 5-80 mol %, or 8-70 mol %, or 10-65 mol %, or >5 mol %, or <80 mol %, based on total amount of conjugated diene units present in the polymer.

In embodiments, an additional modifier is added in the process if additional enhancement of vinyl moieties is desired. The modifiers are selected from the group consisting of dimethyl ether, diethyl ether, tetrahydrofuran (THF), 2-methyl THF, anisole, 1,2-dimethoxyethane, 1,2-diethoxyethane, 1,2-diethoxy propane, 1,2-dimethoxybenzene, triethylamines, tetramethyl ethylene diamine, pentamethyl diethylene triamine, and mixtures thereof.

In embodiments, the polydiene microstructures of butadiene and isoprene are represented by formula (II),

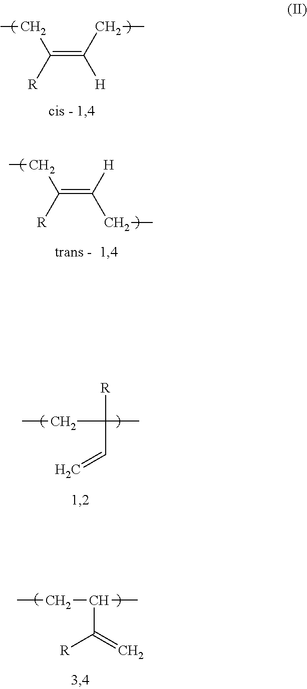

where for butadiene R is H, for isoprene R is methyl (CH₃), for myrcene R is CH₂CH₂CHC (CH₃)₂.

In embodiments, selection of solvents is another way to control or influence the formation of microstructure. The polarity of the solvent used can influence the ratio of 1,4-to 1,2 incorporations. An increase in solvent polarity typically increases the vinyl content.

In embodiments, the microstructure of the resulting copolymer is controlled, either alternatively or in addition to the methods described above, through the selection of the amine-containing moiety of the functional comonomer.

(Functional Comonomer): The functional comonomer (novel) with amine containing moiety exhibits a unique reactivity ratio in a copolymerization with diolefin monomers compared to other styrenic monomers. In embodiments, the functional comonomer is an amino functionalized comonomer comprising one or more amine-derivatized alpha-methyl styrene (ADAMS) according to structure (I):

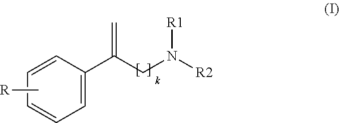

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5-to 12-membered ring, from 3 to 28 carbons, and optionally 1 to 6 additional heteroatoms selected from the group consisting of O, N, S, P, Se, and combinations thereof; R is a hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof.

In embodiments, the comonomers with k=2 are preferred due to case of monomer synthesis and favourable reactivity in the polymerization. Alternatively, monomers with k≥3 may be used, but are more complex to prepare. Alternatively, monomers with k=1 may be used, but difficult to polymerize via anionic polymerization.

In embodiments, the functional copolymers prepared are based on functionalized styrenic monomers including a nitrogen containing moiety not pendant to the phenyl ring. These monomers are polymerized with ADAMS comonomer according to structure (I). Suitable monomers include, but are not limited to, 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazin-1-yl)-3-phenylbut-3-ene, 1-(5-methyl-2,5-diazabicyclo [2.2.1] heptan-2-yl)-3-phenylbut-3-ene, 1-(5-methyl-2,5-diazabicyclo [2.2.2] octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1- piperazinyl)-3-phenylbut-3-ene, 1-(N′-methyl-N-diazepanyl)-3-phenylbut-3-ene, N,N′-bis(3-phenylbut-3-enyl)diazepane, N,N′-bis(3-phenylbut-3-enyl)piperazine, N,N′-bis(3-phenylbut-3-enyl)dihydrophenazine, N,N′-bis(3-phenylbut-3-enyl)dihydrobenzoindazole, N,N′-bis(3-phenylbut-3-enyl)dihydropermidine, N,N′-bis(3-phenylbut-3-enyl)octahydropyridoquinoline, N,N′-bis(3-phenylbut-3-enyl)octahydropyridoisoquinoline, N,N′-bis(3-phenylbut-3-enyl) hexahydropyrroloquinoline, N,N′-bis(3-phenylbut-3-enyl)hexahydropyrroloisoquinoline, N,N′-bis(3-phenylbut-3-enyl)hexahydropyrroloisoindole, N,N′-bis(3-phenylbut-3-enyl)diazabicyclo [2.2.1] heptane, N,N′-bis(3-phenylbut-3-enyl)diazabicyclo [2.2.2] octane, 1,3-bis(1-(3-phenylbut-3-enyl)piperidin-4-yl)propane, bis(1-dimethylamino-3-phenylbut-3-enyl)benzene, bis(1-benzylmethylamino-3-phenylbut-3-enyl)benzene, bis(1-(N-morpholinyl)-3-phenylbut-3-enyl)benzene, bis(1-(N-thiomorpholinyl)-3-phenylbut-3-enyl)benzene, bis(1-(di-methoxyethyl)amino-3-phenylbut-3-enyl)benzene, bis(1-(N-piperidinyl)-3-phenylbut-3-enyl)benzene, bis(1-(N-pyrrolidinyl)-3-phenylbut-3-enyl)benzene, bis(1-(4-methyl-1-piperazinyl))-3-phenylbut-3-enyl)benzene, and combinations thereof.

In embodiments, the functional groups are introduced into a polymer by two general approaches: (1) chemical modification of a nonfunctionalized polymer, or (2) polymerization or copolymerization of monomers containing the functionality. The second method has an advantage of controlling the copolymer structure by the ability to control loading and distribution of functional groups along the polymer backbone and the ability to analyse the monomers prior to polymerization. The second method also has an advantage that, no degradation takes place upon copolymer formation, which often happens with chemical modification approach.

In embodiments, the functional comonomer is incorporated into the copolymerization process by any of: 1-10 addition, 1-5 addition, or 1-2 addition.

In a copolymerization process, the properties of the resulting copolymer can be tailored by controlling the incorporation of a functional comonomer into the polymer backbone. This involves managing how the functional comonomer is distributed along the polymer chain. The terms “1-5 addition,” “1-2 addition,” or “1-10 addition” refer to the desired ratio or pattern of incorporation of the functional comonomer relative to the main monomer (diolefin monomer) in the copolymer chain.

In embodiments, the incorporation of functional comonomer is controlled by: (i) adjusting the ratio of the comonomers in the reaction mixture, and/or (ii) optimizing the reaction conditions, to achieve the desired sequence distribution. To achieve a specific incorporation pattern, the feed ratio of the functional comonomer to the main monomer can be adjusted. For example, for a 1-5 addition sequence, one to five dosages of the functional comonomer added to the conjugated diene polymerization resulting in one to five regions in the copolymer which are rich in functional comonomer.

In embodiments, the functional comonomer is added in an amount ranging from 0.1-20 mol %, or 0.2-15 mol %, or 0.5-10 mol %, or 1-7.5 mol %, or >0.1 mol % or <20 mol %.

In embodiments, the functional comonomer and diolefin monomer are present in a mole ratio of 0.001 to 0.25, or 0.001 to 0.20, or 0.002 to 0.15, or 0.003 to 0.10, or 0.001 to 0.010, or 0.001 to 0.002, or 0.002 to 0.005, or 0.005 to 0.010. In embodiments, the amino functionalized copolymers resulting from the

polymerization have a general configuration A-B, B-A-B, B-A-B-A-B, (B-A-B),X, (B-A),X,, and mixtures thereof, wherein n is an integer from 2 to about 30, and X is a coupling agent residue, and wherein the plurality of A blocks, B blocks, are the same or different. In embodiments, the plurality of A blocks and B blocks are each independently the same or different. The A block comprises a polymerized diolefin monomer, and the B block comprises a polymerized functional comonomer.

In embodiments, the amino functionalized copolymers resulting from the process have distributed monomer units in the structure. The amino functionalized copolymers may be a random copolymer, a tapered block copolymer, a star copolymer, or a block copolymer.

(Optional Divinyl Arene Monomer-DVA): The DVA monomer is optionally added to the copolymerization reaction mixture. The DVA monomer forms the nucleus of the copolymer. The living polymers produced are extended outwardly from the optional nucleus. In embodiments, DVA is selected from the group consisting of: divinylbenzene (DVB), ethylvinylbenzene (EVB), 1,3-divinylnaphthalene, 1,8-divinylnaphthalene, 1,4-divinylnaphthalene, 1,5-divinylnaphthalene, 2,3-divinylnaphthalene, 2,7-divinylnaphthalene, 2,6-divinylnaphthalene, 4,4′-divinylbiphenyl, 4,3′-divinylbiphenyl, 4,2′-divinylbiphenyl, 3,2′-divinylbiphenyl, 3,3′-divinylbiphenyl, 2,2′-divinylbiphenyl, 2,4-divinylbiphenyl, 1,2-divinyl-3,4-dimethylbenzene, 1,3-divinyl-4,5,8-tributylnaphthalene, and 2,2′-divinyl 4-ethyl-4′-propylbiphenyl, and mixtures thereof.

In embodiments, DVA comprises a mixture of m-DVA and p-DVA, wherein m-DVA is present in amounts of >50, or >55, or >60, or >65, or >70, or >75, or >90 wt. %, based on total weight of DVA.

In embodiments, DVA is a divinylbenzene (DVB). Non-limiting examples of DVB include o-divinylbenzene (1,2-divinylbenzene), p-divinylbenzene (1,3-divinylbenzene), m-divinylbenzene (1,4-divinylbenzene), trivinylbenzene, or mixtures thereof. In embodiments, DVB comprises a mixture of two or more of 1,2-divinylbenzene (o-DVB), 1,3-divinylbenzene (m-DVB), 1,4-divinylbenzene (p-DVB), vinyl benzene, and diethylbenzene, In embodiments, DVB contains 50-99, 55-95, or 60-90, or 65-85, or 50-80, or >55, or >60, or >65, or >70, or >80 wt. % of m-DVB, based on total weight of DVB.

In embodiments, DVB has a weight ratio of m-DVB to p-DVB of 1:3 to 3:1, or 1:2.5 to 2.5:1, or 1:2 to 2:1.

In embodiments, DVB has a purity of >90, or >80, or >70, or >60, or >50 wt. %, based on the total weight of DVB. “Purity” of DVB is defined as the presence of a single isomer of greater than certain percentages in the mixture of all isomers, e.g., o-DVB, m-DVB, p-DVB, vinyl benzene, or EVB.

Examples of commercially available DVB monomers include DVB 80, DVB 55, DVB 63 from Deltech Corp., and DVB 55, DVB 63, and DVB HP from DuPont.

In embodiments, other optionally polymerizable monomers include mono, di, or multi-functional compounds selected from the group consisting of: butadiene, isoprene, piperylene, divinyltoluene, divinylpyridine, divinylxylene, vinyltriisopropenoxysilane, methoxytrivinylsilane, tetravinylsilane, diethoxydivinylsilane, o-ethyl vinyl benzene, m-ethylvinylbenzene, p-ethylvinylbenzene, 2-vinyl-2′-ethylbiphenyl, 2-vinyl-3′-ethylbiphenyl, 2-vinyl-4′-ethylbiphenyl, 3-vinyl-2′-ethylbiphenyl, 3-vinyl-3′-ethylbiphenyl, 3-vinyl-4′-ethylbiphenyl, 4-vinyl-2′-ethylbiphenyl, 4-vinyl-3′-ethylbiphenyl, 4-vinyl-4′-ethylbiphenyl, 1-vinyl-2-ethylnaphthalene, 1-vinyl-3-ethylnaphthalene, 1-vinyl-4-ethylnaphthalene, 1-vinyl-5-ethylnaphthalene, 1-vinyl-6-ethylnaphthalene, 1-vinyl-7-ethylnaphthalene, 1-vinyl-8-ethylnaphthalene, 2-vinyl-1-ethylnaphthalene, 2-vinyl-3-ethylnaphthalene, 2-vinyl-4-ethylnaphthalene, 2-vinyl-5-ethylnaphthalene, 2-vinyl-6-ethylnaphthalene, 2-vinyl-7-ethylnaphthalene, 2-vinyl-8-ethylnaphthalene, 2-vinyl-2′-propylbiphenyl, 2-vinyl-3′-propylbiphenyl, 2-vinyl-4′-propylbiphenyl, 3-vinyl-2′-propylbiphenyl, 3-vinyl-3′-propylbiphenyl, 3-vinyl-4′-propylbiphenyl, 4-vinyl-2′-propylbiphenyl, 4-vinyl-3′-propylbiphenyl, 4-vinyl-4′-propylbiphenyl, 1-vinyl-2-propylnaphthalene, 1-vinyl-3-propylnaphthalene, 1-vinyl-4-propylnaphthalene, i-vinyl-5-propylnaphthalene, 1-vinyl-6-propylnaphthalene, 1-vinyl-7-propylnaphthalene, 1-vinyl-8-propylnaphthalene, 2-vinyl-1-propylnaphthalene, 2-vinyl-3-propylnaphthalene, 2-vinyl-4-propylnaphthalene, 2-vinyl-5-propylnaphthalene, 2-vinyl-6-propylnaphthalene, 2-vinyl-7-propylnaphthalene, 2-vinyl-8-propylnaphthalene, 1,2,4-trivinylbenzene, 1,3,5-trivinylbenzene, 1,2,4-triisopropenylbenzene, 1,3,5-triisopropenylbenzene, 1,3,5-trivinylnaphthalene, 3,5,4′-trivinylbiphenyl, acenaphthylenes such as alkylacenaphthylenes, phenylacenaphthylenes, and mixtures thereof. Examples of the alkyl acenaphthylenes include 1-methyl acenaphthylene, 3-methyl acenaphthylene, 4-methyl acenaphthylene, 5-methyl acenaphthylene, 1-ethyl acenaphthylene, 3-ethyl acenaphthylene, 4-ethyl acenaphthylene, 5-ethyl acenaphthylene, and mixtures thereof. Examples of phenylacenaphthylenes include 1-phenylacenaphthylene, 3-phenylacenaphthylene, 4-phenylacenaphthylene, 5-phenylacenaphthylene, and mixtures thereof.

In embodiments, the other optionally polymerizable monomers further include (i) a cyclodiene or a dimer thereof; (ii) an adduct of a cyclodiene and an acyclic diene; (iii) an allyl compound having two or more allyl groups; and any combination or sub-combination thereof. Examples of cyclic polymerizable monomers include 1,3-cyclohexadiene, 1,4-cyclohexadiene, 1,3-cyclopentadiene, alkyl cyclopentadiene, trivinylcyclohexane, 2,4,6,8-tetravinyl-2,4,6,8-tetramethylcyclotetrasiloxane, 2,4,6,8, 10-pentamethyl-2,4,6,8,10-pentavinylcyclopentasiloxane, or mixtures thereof.

In embodiments, the other optionally polymerizable monomers further include any of styrene, o-methyl styrene, p-methyl styrene, p-tertbutyl styrene, 2,4-dimethyl styrene, alpha-methyl styrene, vinylnaphthalene, vinyltoluene, vinylxylene, or mixtures hereof. In embodiments, the monoalkenyl arene block comprises a substantially pure monoalkenyl arene monomer. In some embodiments, styrene is the major component with minor proportions (less than 10 wt. %) of structurally related vinyl aromatic monomers such as o-methylstyrene, p-methyl styrene, p-tert-butyl styrene, 2,4-dimethyl styrene, a-methylstyrene, vinylnaphtalene, vinyltoluene, vinylxylene, or combinations thereof.

In embodiments, the polymerization reaction is terminated by an alcohol terminating agent. In polymerization reactions, particularly in living polymerization such as anionic polymerization, the reaction can be terminated by adding an alcohol terminating agent. The alcohol reacts with the active chain end, neutralizing it and effectively stopping the polymerization process.

In embodiments, the alcohol terminating agents are selected from the group consisting of: methanol, ethanol, isopropanol, n-butanol, t-butanol, 1-hexanol, 1-octanol, 1-dodecanol, benzyl alcohol, cyclohexanol, and mixtures thereof. In embodiments the copolymer is contacted with an alcohol prior to the optional hydrogenation step.

In embodiments, conjugated diene or olefin segments of the amine functionalized copolymer are optionally hydrogenated. The hydrogenation can be controlled to only the residual double bond in the diene fraction or also the substituent on the amine moiety of the functionalized comonomer. In some cases, it is necessary to selectively hydrogenate the copolymer to remove any ethylenic unsaturation from blocks A and/or B. Hydrogenation generally improves thermal stability, ultraviolet light stability, oxidative stability, and, therefore, weatherability of the final polymer. In embodiments, hydrogenation is carried out via any of the several hydrogenation or selective hydrogenation processes known in the art, c.g., hydrogenation methods such as those taught in, U.S. Pat. No. 3,595,942, U.S. Pat. No. 3,634,549, U.S. Pat. No. 3,670,054, U.S. Pat. No. 3,700,633, and US Re. 27,145, incorporated herein by reference.

In embodiments, the conjugated diene is partially or fully hydrogenated. The conjugated diene has a hydrogenation level of 15-99.9%, or >20%, or 30-95%, or >40%, or <70%, or <80%, or <99.9%. Hydrogenation level refers to the percentage of original unsaturated bonds which become saturated upon hydrogenation. Hydrogenation level in vinyl aromatic polymers can be determined using ¹H NMR. Hydrogenation level in the diene polymers can be determined using ¹H NMR.

(Process to Prepare Functionalized Copolymer): The functionalized copolymer is prepared by an anionic polymerization process having the following steps:
(a) polymerizing one or more monomers in an inert hydrocarbon solvent in the presence of an alkyl lithium initiator,
(b) optionally adding one or more sequential additions of one or more monomers of the same or different composition,
(c) optionally adding a polyfunctional coupling agent to couple some or all of the polymer or copolymer, and
(d) adding a terminating agent.

In embodiment, the anionic polymerization process is initiated with alkyl lithium reagents, e.g., with sec-butyllithium, although other mono-and di-functional alkyl lithium initiators can be used. The monofunctional initiator, if used, can be an alkyl lithium, alkyl sodium, or alkyl potassium compound, in the C2 to C12 range. Alkyl lithium compounds such as methyllithium, ethyllithium, n-propyllithium, isopropylithium, n-butyllithium, iso-butyllithium, sec-butyllithium, tert-butyllithium, n-amyllithium, iso-amyllithium, sec-amyllithium, tert-amyllithium, hexyllithium, or a combination thereof, are preferred. Secondary alkyl lithium compounds, such as sec-butyllithium, sec-amyllithium, or a combination thereof, are more preferred. Most preferred is sec-butyllithium. Substituted alkyllithiums may also be used, such as aralkyllithium compounds, for example, benzyllithium, 1-lithioethylbenzene, and 1-lithio-3-methylpentylbenzene.

In embodiments, the difunctional initiator used is an alkyl dilithium, alkyl disodium, or alkyl dipotassium compound, generally in the C2 to C12 range, such as 1,3-propanediyldilithium, 1,4-butanediyldilithium, 1,5-pentanediyldilithium, 1,6-hexanedilyllithium, or a combination thereof. Additional difunctional initiators are disclosed in U.S. Pat. No. 6,492,469, which is herein incorporated by reference in its entirety.

In embodiments, the functionalized monomers having a nitrogen-containing moiety, are co-polymerized with isoprene, butadiene, and combinations thereof. The novel anionic polymerization process in which the functionalized comonomers are introduced in the copolymer, happens in solution in an inert hydrocarbon solvent in the presence of an alkyl lithium initiator. The inert hydrocarbon solvent may be any hydrocarbon, generally from 5 to 8 carbons, or mixtures thereof, which does not react with the alkyl lithium initiator or the ‘living’ anionic chain end of the polymer backbone and offers appropriate solubility characteristics for the product polymer. Non-limiting examples of appropriate solvents are cyclic alkanes, such as cyclopentane, cyclohexane, cycloheptane, and cyclooctane, all of which are relatively non-polar.

In embodiments, depending on the monomers and the reaction solvent, the polymerization reaction is carried out at a temperature of −80° C. to 200° C., alternatively from −40° C. to 150° C., preferably from 0° C. to 100° C., and more preferably, from 20° C. to 90° C. In some examples, the polymerization of the functionalized comonomers and copolymerization with other comonomers and blocks can be carried out at room temperature, or alternatively from 15 to 70° C., alternatively from 20 to 60° C., alternatively from 25 to 50° C., or combinations of these temperatures, or individual temperatures within such ranges.

In embodiments, the polymerization reaction is carried out under a dry, inert atmosphere, preferably nitrogen, and is also carried out under pressure within the range of from 0 bar to 10 bar.

In embodiments, the polymerization process is conducted in the presence of polar modifiers, such as alkyltetrahydrofurfuryl ethers, methyltetrahydrofurfuryl ether, ethyltetrahydrofurfuryl ether, propyltetrahydrofurfuryl ether, butyltetrahydrofurfuryl ether, hexyltetrahydrofurfuryl ether, octyltetrahydrofurfuryl ether, dodecyltetrahydrofurfuryl ether, diethyl ether, di-n-propyl ether, diisopropyl ether, di-n-butyl ether, tetrahydrofuran, dioxane, ethylene glycol dimethyl ether, ethylene glycol diethyl ether, diethylene glycol dimethyl ether, diethylene glycol diethyl ether, triethylene glycol dimethyl ether, trimethylamine, triethylamine, N,N,N′, N′tetramethylethylenediamine, N-methyl morpholine, N-ethylmorpholine, or N-phenyl morpholine.

In embodiments, the polar modifier is employed at a level wherein the molar ratio of the polar modifier to the lithium initiator is 0.01:1 to 5:1, or 0.1:1 to 4:1, or 0.25:1 to 3:1. or 0.5:1 to 3:2.

In embodiments, upon completion of the polymerization reaction, a terminating agent is added to stop the reaction and quench the reactive ‘living’ anionic chain end of the polymer backbone. The polymerization terminating agent can be either various primary or secondary alcohols or an epoxide terminating agent. Non-limiting examples of the various primary or secondary alcohols include methanol, ethanol, isopropanol, 2-ethyl-1-hexanol, and the like, or a combination thereof. Non-limiting examples of the epoxide terminating agent include ethylene oxide, propylene oxide, butylene oxide, styrene oxide, methyl glycidyl ether, ethyl glycidyl ether, propyl glycidyl ether, butyl glycidyl ether, benzyl glycidyl ether, phenyl glycidyl ether, and the like, or a combination thereof.

In embodiments, the copolymer of functionalized monomer having a nitrogen-containing moiety, is optionally isolated or purified according to various general polymer isolation or purification techniques which are known in the art, e.g., pouring the polymerization reaction solution into a poor solvent of the polymer, such as methanol to solidify the polymers, or pouring the polymerization reaction solution into hot water together with a steam to remove the solvent by azeotropy (steam stripping) and drying the resultant product.

In embodiments, the copolymer, terminated by the terminating agent are optionally joined by a nucleus comprising a linking compound or a coupling agent having at least two reactive sites. In embodiments, the linking compound is selected from the group consisting of: 1,2-divinylbenzene, 1,3-divinylbenzene, 1,4-divinylbenzene, 1,2,4-trivinylbenzene, 1,3-divinylnaphthalene, 1,8-divinylnaphthalene, 1,2-diisopropenylbenzene, 1,3-diisopropenylbenzene, 1,4-diisopropenylbenzene, 1,3,5-trivinylnaphthalene, 2,4-divinylbiphenyl; 3,5,4′-trivinylbiphenyl, 1,2-divinyl-3,4-dimethylbenzene, 1,5,6-trivinyl-3,7-diethylnaphthalene, 1,3-divinyl 4,5,8-tributylnaphthalene, and mixtures thereof.

In embodiments, the coupled copolymer has a coupling efficiency of 50-80%, or 55-75%, or >50%, or >55%, or >60%, or <80%.

In embodiments, the functionalized copolymers (copolymers) are prepared in various ways as schematically illustrated in the following scheme (I):

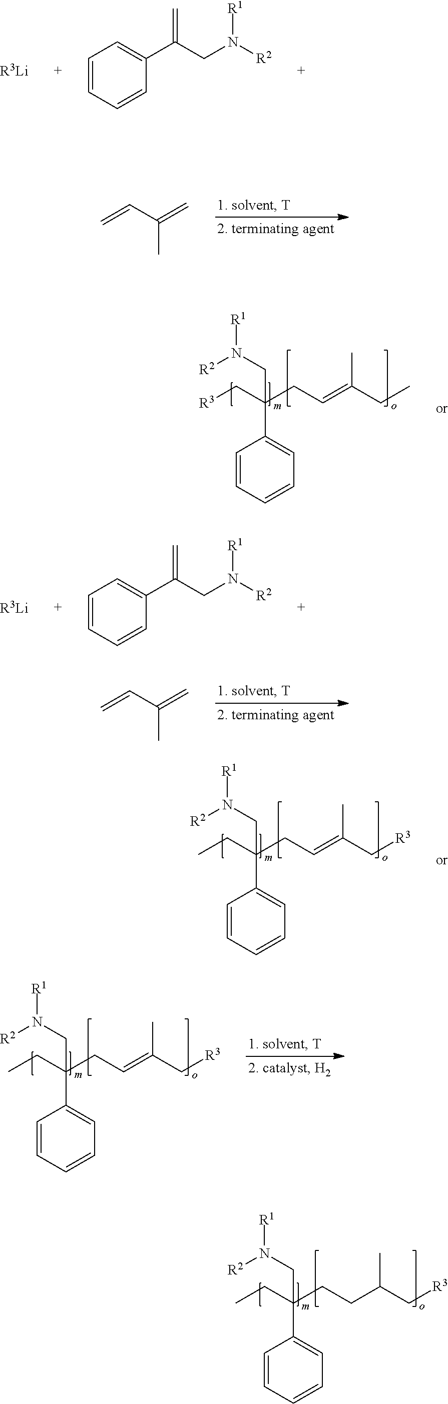

R¹ and R² are each independently a hydrocarbyl group or a hydrocarbonaceous group having 1 to 4 additional heteroatoms selected from the group consisting of O, N, S, P, Se, and combinations thereof. R³-alkyl group (C2-C12) and m and o are independently ≥2.

In embodiments, the linking of the functional copolymer (copolymer) to the molecules of linking compound (e.g. DVB) is conducted with continuous stirring at approximately 25° C. and is generally completed within about 8 hours or less.

In embodiments, the resultant copolymer product is optionally hydrogenated with a hydrogenation catalyst selected from the group consisting of: cobalt, nickel, titanium, platinum, palladium, and mixtures thereof.

In embodiments, the polymerization and recovery of polymer are suitably carried out according to various methods suitable for diene monomer polymerization processes. This includes batchwise, semi-continuous, or continuous operations under conditions that exclude air and other atmospheric impurities, particularly oxygen and moisture. The polymerization of the amine functionalized monomers may be carried out in a number of different polymerization reactor systems, including but not limited to bulk polymerization, vapor phase polymerization, solution polymerization, suspension polymerization, emulsion polymerization, and precipitation polymerization systems. The commercially preferred method of polymerization is solution polymerization.

(Properties of Functional Copolymer): In embodiments, the copolymer has a solubility in a hydrocarbon solvent at 25° C. within a period of less than 4 hours, in an amount ranging from 10-75 wt. %, or 20-65 wt. %, or 10-60 wt. %, or at least 10 wt. %, or >20 wt. %, or >30 wt. %, or >50 wt. %, or >70 wt. %, or <75 wt. %, based on the total weight of the solvent. Examples of solvents include hexane, heptane, octane, isooctane, cyclohexane, varnish maker and painter's naphtha (VM&P naphtha), petroleum ether, toluene, xylene, and mixtures thereof.

In embodiments, the copolymer has a decomposition onset temperature of 180-450° C., or 220-420° C., or 240-400° C., or <600° C., or <500° C. or >300° C.

(Analytical Methods): The incorporation of the diolefin monomer can be detected and quantified by proton nuclear magnetic resonance (¹H NMR) and carbon-13 NMR (1³C NMR) spectroscopy with a solvent, e.g., CD₂Cl₂, tetrachloroethane. Fourier-transform infrared (FTIR) spectroscopy can also be used to identify characteristic carbon-carbon double bond vibrations indicative of residual unsaturation.

The presence of the functional comonomer can be detected by 1H NMR and mass spectrometry, such as Matrix-Assisted Laser Desorption Ionization Time-of-Flight (MALDI-TOF) mass spectrometry. FTIR spectroscopy can also be used to reveal characteristic functional group absorptions corresponding to the heteroatom content or aromatic substituents of the functional comonomer.

Detection of DVB-derived structural features can be performed using solid-state NMR, gel permeation chromatography (GPC) coupled with multi-angle light scattering (MALS) or viscometry, and FTIR.

If the copolymer is optionally hydrogenated, the extent of hydrogenation can be assessed by 1H NMR through the disappearance or reduction of unsaturation signals. Additional methods such as UV-visible spectroscopy and iodine number titration can complement this analysis by providing quantitative measures of residual unsaturation.

The detection of specific chain-end groups arising from the anionic initiator, or from DVB termination, may be carried out using high-resolution NMR and MALDI-TOF mass spectrometry.

### EXAMPLES

### The Following Illustrative Examples are Intended to be Non-Limiting

The components (materials) used in examples include:

Cyclohexane, isoprene and all ADAMS monomers were purified by activated aluminum oxide under inert atmosphere and stored under nitrogen. Comonomers were stored at 4° C. ADAMS monomers were optionally diluted with purified cyclohexane before use. 2-Ethylhexanol (2EH) and methanol (MeOH) were purged with nitrogen before use. Sec-Butyllithium was diluted with purified cyclohexane before use. Yubase 4 was used as received.

All polymerizations were conducted under an inert (N2) atmosphere. Two autoclave setups were used with different volume capacities of 2L and 10L, respectively. Both are equipped with in-line Mid-Infrared and UV-Vis spectroscopy capabilities. Cyclohexane was used as the solvent, sec-butyllithium (solution in cyclohexane) as the initiator, and 2-ethyl-hexanol (2EH) or methanol (MeOH) as the terminating agents.

### Example 1

(Category 1): All polymers of this category were synthesized via the following general procedure: Step 1: The desired amount of solvent was added to the autoclave, stirred, and heated to the desired temperature per experiment (Table X2). Occasionally the temperature setpoint was increased during the process, and this is noted in Table X2. Step 2: The functional comonomer was then added to the reactor, followed by the addition of isoprene. Step 3: Sec-butyllithium solution was added to the autoclave for initiation of the polymerization reaction. Step 4: The rest of the functional comonomer was added in further dosages/shot(s). Each additional functional comonomer shot was introduced when the majority of the previous amount of the functional comonomer was converted, as confirmed by ¹H NMR (aliquot taken from the reaction mixture). Step 5: After nearly complete conversion of both isoprene and functional comonomer, the reaction was terminated via stepwise termination using aliquots of methanol or 2-ethyl-hexanol solutions in cyclohexane. The stepwise termination was monitored via UV-VIS and was considered complete when no more change was visible.

### Example 2

(Category 2): These polymers were also synthesized under inert N₂ atmosphere, utilizing the same reactor setups, same solvent (cyclohexane) and sec-butyllithium solution as the initiator. 2-ethyl-hexanol was the only terminating alcohol in these experiments. Steps 1 & 3 are identical to the experiments of Category 1. Step 2: included full addition of the functional comonomer into the autoclave followed by partial or complete addition of isoprene. Step 4: includes further isoprene addition in shots until the majority of the functional comonomer has been consumed. Step 5: only refers to examples 8 and 9 and is the addition of a coupling agent. in this case divinylbenzene (DVB), and Step 6: is stepwise termination with 2-ethyl-hexanol.

TABLE X2

| | Temp | Temp sp | | | | | | | | | | |
|---|---|---|---|---|---|---|---|---|---|---|---|---|
| | Set- | change | Total | | | FC additions | | Isoprene | Sec- | | | |
| | point | (° C.)/ | monomer | Functional | FC (g)/ | Time^{a} | Iso- | addition/ | BuLi | | | |
| Category | (sp) | Time^{a} | In rm^{c} | Comonomer | [FC] | (min) | prene | Time^{a} | ml/ | DVB | 2EH^{b} | MeOH^{b} |
| example | (° C.) | (min) | (%) | (FC) | w % | % of total FC | (g) | (min) | [M] | (g) | (g) | (g) |
| 1.1 | 35 | — | 15 | 1- | 149.4/ | 1^{st} @ −31 min 64% | 675.3 | 1^{st} @ −10 min | 57/ | — | 36.4 | — |
| | | | | benzylmethyl | 100% | 2^{nd} @ 100 min 36% | | | [0.59] | | | |
| | | | | amino-3- | | | | | | | | |
| | | | | phenylbut-3- | | | | | | | | |
| | | | | ene | | | | | | | | |
| 1.2 | 35 | 45/300 | 18 | 1- | 314.1/ | 1^{st} @ −47 min 50% | 880.1 | 1^{st} @ −25 min | 60/ | — | 31.8 | — |
| | | min | | benzylmethyl | 38% | 2^{nd} @ 96 min 50% | | | [0.58] | | | |
| | | | | amino-3- | | | | | | | | |
| | | | | phenylbut-3- | | | | | | | | |
| | | | | ene | | | | | | | | |
| 1.3 | 35 | 50/195 | 18 | 1- | 120.0/ | 1^{st} @ 65 min 100% | 880.0 | 1^{st} @ −21 min | 60/ | — | 32.0 | — |
| | | min | | benzylmethyl | 38% | | | | [0.58] | | | |
| | | | | amino-3- | | | | | | | | |
| | | | | phenylbut-3- | | | | | | | | |
| | | | | ene | | | | | | | | |
| 1.4 | 35 | — | 15 | 1- | 16.7/ | 1^{st} @ −25 min 75% | 123.0 | 1^{st}@ −13 min | 14/ | — | 5.9 | — |
| | | | | benzylmethyl | 50% | 2^{nd} @ 89 min 25% | | | [0.50] | | | |
| | | | | amino-3- | | | | | | | | |
| | | | | phenylbut-3- | | | | | | | | |
| | | | | ene | | | | | | | | |
| 1.5 | 35 | — | 15 | 1-(N- | 42.9/ | 1^{st} @ −60 min 33.3% | 781.0 | 1^{st} @ −10 min | 59/ | — | — | 28.2 |
| | | | | morpholinyl)- | 100% | 2^{nd} @ 30 min 33.3% | | | [0.56] | | | |
| | | | | 3-phenylbut- | | 3^{rd} @ 60 min 33.3% | | | | | | |
| | | | | 3-ene | | | | | | | | |
| 1.6 | 35 | — | 15 | 1-(N- | 43/ | 1^{st} @ −24 min 33.3% | 781.1 | 1^{st}@ −10 min | 63/ | — | — | 23.4 |
| | | | | morpholinyl)- | 100% | 2^{nd} @ 30 min 33.3% | | | [0.56] | | | |
| | | | | 3-phenylbut- | | 3^{rd} @ 60 min 33.3% | | | | | | |
| | | | | 3-ene | | | | | | | | |
| 2.7 | 50 | 60/139 | 15 | benzylphenyl | 17.2/ | 1^{st} @ −11 min 100% | 135.0 | 1^{st} @ 9 min | 14/ | — | 5.6 | — |
| | | min | | amino-3- | 40% | | | 24.2% | [0.55] | | | |
| | | | | phenylbut-3- | | | | 2^{nd} @ 162 min | | | | |
| | | | | ene | | | | 24.2% | | | | |
| | | | | | | | | 3^{rd} @ 266 min | | | | |
| | | | | | | | | 24.2% | | | | |
| | | | | | | | | 4^{th} @ 358 min | | | | |
| | | | | | | | | 24.2% | | | | |
| | | | | | | | | 5^{th} @ 488 min | | | | |
| | | | | | | | | 3.3% | | | | |
| 2.8 | 45 | 60/281 | 8.6 | benzylphenyl | 11.9/ | 1^{st} @ −7 min 100% | 65.0 | 1^{st} @ 93 min | 30/ | 6.3 | 13.1 | — |
| | | min | | amino-3- | 38% | | | | [0.53] | | | |
| | | | | phenylbut-3- | | | | | | | | |
| | | | | ene | | | | | | | | |
| 2.9 | 45 | 60/171 | 8.6 | benzylphenyl | 19.8/ | 1^{st} @ −30 min 100% | 64.4 | 1^{st} @ 95 min | 50/ | 10.4 | 20.7 | — |
| | | min | | amino-3- | 100% | | | | [0.53] | | | |
| | | | | phenylbut-3- | | | | | | | | |
| | | | | ene | | | | | | | | |
| 2.10 | 50 | — | 15 | 1-(4-methyl- | 17.8/ | 1^{st} @ −25 min 100% | 119.6 | 1^{st} @ −10 min | 12/ | — | 4.3 | — |
| | | | | piperazin-1- | 100% | | | 2^{nd} @ 190 min | [0.53] | | | |
| | | | | yl)-3- | | | | | | | | |
| | | | | phenylbut-3- | | | | | | | | |
| | | | | ene | | | | | | | | |
| 1.11 | 35 | — | 15 | 1-(4-methyl- | 45.6/ | 1^{st} @ −25 min 33.3% | 778.2 | 1^{st} @ −10 min | 66/ | — | — | 38.8 |
| | | | | piperazin-1- | 100% | 2^{nd} @ 50 min 33.3% | | | [0.56] | | | |
| | | | | yl)-3- | | 3^{rd} @ 120 min 33.3% | | | | | | |
| | | | | phenylbut-3- | | | | | | | | |
| | | | | ene | | | | | | | | |
| 1.12 | 45 | — | 15 | 1-(4-methyl- | 91.2/ | 1^{st} @ −10 min 25% | 732 | 1^{st} @ −17 min | 66/ | — | — | 28.1 |
| | | | | piperazin-1- | 100% | 2^{nd} @ 24 min 25% | | | [0.56] | | | |
| | | | | yl)-3- | | 3^{rd} @ 90 min 25% | | | | | | |
| | | | | phenylbut-3- | | 4^{th} @ 210 min 25% | | | | | | |
| | | | | ene | | | | | | | | |

^{a}time relative to initiation (addition of BuLi);
^{b}solution in cyclohexane;
^{c}rm = reaction mixture

### Results of Examples 1 and 2

TABLE X3

| | | Micro- | Micro- | Micro- | |
|---|---|---|---|---|---|
| | | structure | structure | structure | |
| | | Poly- | Poly- | Poly- | Coupling |
| Category | Mp | isoprene | isoprene | isoprene | Efficiency |
| example | (kg/mol) | 1.4% | 3.4% | 1.2% | (%) |
| 1.1 | 52.7 | 87.7 | 12 | 0.3 | N/A |
| 1.2 | 46 | 90 | 10 | 0 | N/A |
| 1.3 | 45.8 | 88 | 12 | 0 | N/A |
| 1.4 | 46.8 | 89 | 11 | 0 | N/A |
| 1.5 | 42.1 | 72.2 | 27 | 0.8 | N/A |
| 1.6 | 38.3 | 73.4 | 26 | 0.6 | N/A |
| 2.7 | 55.7 | 88 | 12 | 0 | N/A |
| 2.8 | 150 | 94 | 6 | 0 | 96 |
| 2.9 | 110 | 93.5 | 6.5 | 0 | 90 |
| 2.10 | 35.9 | 69.3 | 30 | 0.7 | N/A |
| 1.11 | 38.6 | 76.3 | 23 | 0.7 | N/A |
| 1.12 | 24.0 | 77.2 | 22 | 0.8 | N/A |

### Example-3

The process for hydrogenation of the polymers described above typically follows the following procedure: The reaction mixture is transferred from the polymerization reactor to a hydrogenation reactor under inert atmosphere. The polymer was then hydrogenated by introducing hydrogen gas at 40 bars and a temperature of 50° C. or 70° C., in the presence of approximately 5 ppm of a cobalt/aluminum catalyst (mg Co/kg reaction mixture). In the next step aliquots of catalyst is added until the desired conversion is reached, and the temperature was maintained at, or raised to 70° C. or 90° C. Total catalyst added ranges from 50 to 150 ppm. Then the catalyst was removed by washing the polymer solution with demineralized water only or with an aqueous phosphoric acid solution at 75° C. After neutralization with aqueous ammonia and an addition of 0.2 parts per hundred resins (“phr”) of Irganox 1010, the solvent was removed from the hydrogenated copolymer via a solvent swap method: first removing about 60% of the cyclohexane, next adding Yubase oil and removing the rest of the cyclohexane. The resulting composition is a composition of the copolymer in Yubase oil, the composition of which was determined by Thermographic Analysis (TGA). A sample aliquot was taken from the cyclohexane solution for characterization of polymer by GPC and 1H NMR.

### Example-3b

With respect to polymer examples 1.2 and 1.3, two hydrogenation conversion targets were set for each of these precursors. Therefore, the polymer amount collected right after polymerization was divided into 2 parts and each part was hydrogenated separately aiming for different conversions resulting in polymer examples 1.2H1 and 1.2H2 and 1.3H1 and 1.3H2.

### Results of Examples 3 and 3b.

TABLE X4

| | | | Hydrogenation | |
|---|---|---|---|---|
| Precursor | (partially) | | conversion of | |
| polymer | hydrogenated | Mp | polydiene | Polymer |
| example | polymer example | (kg/mol)^{a} | unsaturation^{b} | % in oil |
| 1.1 | 1.1H | 64 | 90 | 30 |
| 1.2 | 1.2H1 | 53.7 | 87 | 50 |
| 1.2 | 1.2H2 | 56 | 99.5^{d} | 50 |
| 1.3 | 1.3H1 | 55.8 | 92 | 49 |
| 1.3 | 1.3H2 | 56.3 | 99.5^{d} | 51 |
| 1.4 | 1.4H | 54.2 | >99^{d} | 46 |
| 1.5 | 1.5H | 45.1 | 87 | 50 |
| 1.6 | 1.6H | 41.2 | 92 | 50 |
| 2.7 | 2.7H | 62.5 | nm | nm |
| 2.8 | 2.8H | 153 | 85 | 97^{e} |
| 2.9 | 2.9H | 123.5 | 68 | 43 |
| 2.10 | 2.10H | 40.9 | 75 | 46 |
| 1.11 | 1.11H | 41 | 95 | 44 |
| 1.12 | 1.12H | 26.5 | 88 | 47 |

^{a}measured by GPC
^{b}measured by ¹H NMR (in all cases the pendant phenyl moiety resulting from the styrenic moiety (thus not a substituent of the amine N remains intact through the hydrogenation process.)
^{e}measured by TGA
^{d}at this conversion level the benzyl-moiety of the 1-benzylmethylamino-3-phenylbut-3-ene is saturated too.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “includes” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. The recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A process for preparing a copolymer comprising the steps of:
(a) copolymerizing in an organic solvent and an anionic initiator a reaction mixture containing:
(i) at least one diolefin monomer selected from the group consisting of: 1,3-butadiene, isoprene, and mixtures thereof and
(ii) a functional comonomer having a structure of formula (I): 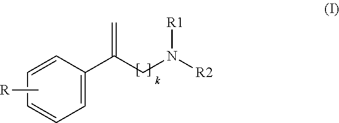
wherein: k is an integer from 1 to 3,
R is any of hydrogen or a phenyl group,
R1 and R2 are each independently a hydrocarbyl group or a hydrocarbonaceous group having 1 to 4 additional heteroatoms selected from the group consisting of O, N, S, P, Se, and combinations thereof,
R1 and R2 are connected to form a moiety containing at least one 5-to 12-membered ring and 3 to 28 carbons,
at a mole ratio of (i) to (ii) in a range of 0.001 to 0.20, forming the copolymer with a reactive chain end comprising diene repeat units derived from the diolefin monomer and repeat units derived from the functional comonomer, wherein the copolymer has a vinyl moiety in the diene repeat units;
(b) optionally adding divinylbenzene (DVB) to the reaction mixture containing the copolymer with the reactive chain end;
(c) terminating the copolymerization by adding a proton donor selected from the group consisting of alcohol, hydrogen, water, and mixtures thereof; and
(d) optionally hydrogenating the copolymer via a hydrogenation catalyst.

2. The process of claim 1, wherein the moiety formed by connecting R1 and R2 further comprises 1 to 6 additional heteroatoms, each independently selected from the group consisting of O, N, S, P, Se, and combinations thereof.

3. The process of claim 1, wherein the functional comonomer is selected from the group consisting of 1-(N-morpholinyl)-3-phenylbut-3-ene and 1-(4-methyl piperazin-1-yl)-3-phenylbut-3-ene.

4. The process of claim 1, wherein the functional comonomer is selected from the group consisting of 1-benzylmethylamino-3-phenylbut-3-ene and benzylphenylamino-3-phenylbut-3-ene.

5. The process of claim 1, wherein the functional comonomer is incorporated into the copolymer by 1-10 addition.

6. The process of claim 1, wherein the functional comonomer is incorporated into the copolymer by 1-5 addition.

7. The process of claim 1, wherein the functional comonomer is incorporated into the copolymer by 1-2 addition.

8. The process of claim 1, wherein the functional comonomer when used in an organic solvent, increases the vinyl moiety of the diene repeat units by at least 20% in the absence of a vinyl modifier, wherein the organic solvent is an apolar solvent.

9. The process of claim 1, wherein the functional comonomer when used in the organic solvent, maintains the vinyl moiety in the diene repeat units at less than 15% in the absence of an additional vinyl modifier.

10. The process of claim 1, wherein the vinyl moieties in the diene repeat units correspond to a vinyl content in the range of 5 mol % to 80 mol %, as determined by ¹H-NMR spectroscopy.

11. The process of claim 1, wherein repeat units derived from the functional comonomer in the copolymer are present in an amount of 0.2 mol % to 15 mol %.

12. The process of claim 1, wherein the copolymerization temperature is between 30° C. and 110° C.

13. The process of claim 1, wherein the anionic initiator is selected from the group consisting of: sodium methoxide (NaOMe), potassium tert-butoxide (KOtBu), organolithium, phenylmagnesium bromide (PhMgBr), sodium amide (NaNH2), lithium diisopropylamide (LDA), tert-butylsulfonate anion (TsO⁻), phenylsulfonate anion (PhSO₃⁻), and mixtures thereof.

14. The process of claim 13, wherein the anionic initiator is an organolithium compound selected from: n-butyllithium (n-BuLi), sec-butyllithium (s-BuLi), tert-butyllithium, and mixtures thereof.

15. The process of claim 1, wherein the organic solvent is selected from the group consisting of: cyclohexane, hexanes, toluene, and mixtures thereof.

16. The process of claim 1, wherein divinylbenzene (DVB) is added to the reaction mixture, and wherein the divinylbenzene reacts with the reactive chain end of the copolymer to form a functional copolymer having a divinylbenzene nucleus.

17. The process of claim 16, wherein the divinylbenzene is a coupling agent having at least two reactive sites.

18. The process of claim 16, wherein the functional copolymer is a coupled functional copolymer having a coupling efficiency of 50-80%.

19. The process of claim 16, further comprising contacting the functional copolymer with an alcohol prior to hydrogenation.

20. The process of claim 1, wherein the copolymer is hydrogenated via the hydrogenation catalyst selected from the group consisting of: cobalt, nickel, titanium, platinum, palladium, and mixtures thereof.
